(19) United States
(12) Patent Application Publication
(10) Pub. No.: US 2011/0084233 A1
(43) Pub. Date: Apr. 14, 2011

(54) Scintillation materials in single crystal or polycrystalline form with improved properties, especially light yield and strain birefringence

(76) Inventors: Johann-Christoph Von Saldern, Jena (DE); Christoph Seitz, Jena (DE); Lutz Parthier, Kleinmachnow (DE); Jochen Alkemper, Klein-Winterheim (DE)

(21) Appl. No.: 12/899,937

(22) Filed: Oct. 7, 2010

Related U.S. Application Data
(60) Provisional application No. 61/250,107, filed on Oct. 9, 2009.

(51) Int. Cl. C09K 11/61

(52) U.S. Cl. 252/301.4 H

(57) ABSTRACT

The scintillation material is a compound of the general formula LnX₃:D, in which Ln is Sc, Y, La, Ce, Pr, Nd, Pm, Sm, Eu, Gd, Tb, Dy, Ho, Er, Tm, Yb and/or Lu; X is F, Cl, Br or I, and D is at least one cation of elements Y, Zr, Pd, Hf and Bi as dopant and is contained in the material in an amount of 10 ppm to 10,000 ppm. When the scintillation material includes the preferred CeBr₃ and Bi as a cationic dopant, it also includes at least one other cation of the elements Y, Zr, Pd and Hf. The scintillation material may be in single crystal or polycrystalline form.

### CROSS-REFERENCE

The invention claimed and described herein below is also described in U.S. Provisional Application 61/250,107, filed on Oct. 9, 2009. The aforesaid U.S. Provisional Application, whose entire subject matter is incorporated by explicit reference thereto, provides the basis for a claim of priority of invention for the invention described and claimed herein below under 35 U.S.C. 119 (e).

### BACKGROUND OF THE INVENTION

The present invention relates to scintillation materials based on halides which have improved properties because of their composition. In particular the scintillation materials of the present invention distinguish themselves by high mechanical ruggedness and low strain birefringence (SBR) as well as by a high homogeneity of their refractive index (HOM).

Prior art scintillation materials have elevated fracture sensitivity, which considerably complicates their processing. The manufacturing processes for the known materials lead to low yields. This fracture sensitivity is due essentially to inhomogeneities in the material, to thermal strains and to crystal defects.

Hence the mechanical processing of the known materials, such as separation, grinding and polishing, is very limited or very expensive. At the same time, the number of rejects is higher.

Water and oxygen in the processed raw materials or stemming from the environment lead to formation of oxyhalogen compounds in the melt. During crystallization, because of precipitate formation, these compounds cause strains, which exert a negative effect on the mechanical properties and bring about an elevated tendency toward breakage. Moreover these compounds reduce the light yield or light output.

In the prior art scintillation materials, the resulting thermal strains lead to a considerable strain birefringence and to refractive index non-uniformity. In the case of single crystal materials, these deficiencies also contribute to the, in some cases considerable, crystal-to-crystal differences in scintillation properties and mechanical characteristics.

U.S. Pat. No. 7,405,404 B1 describes a CeBr₃ scintillator which is used for γ-ray or X-ray detection. CeBr₃ can be doped with Lu, La, Eu, Pr, Sr, Tl, Cl, F, or I. The dopant is present in an amount of at least 0.1 mol % to 100 mol %. Y, Hf, Zr, Pd and Bi are not mentioned as dopants. Moreover nothing is said about the mechanical properties.

EP 1 930 395 A2 discloses scintillator compositions prepared from various pre-scintillator compositions. The pre-scintillator compositions can contain rare earths of the lanthanoid series and bismuth as the main constituents. Nothing is said about the use of bismuth as a dopant. Moreover, no information is provided about the mechanical properties.

US 2008/0067391 A1 discloses among other things single-crystal scintillators having the formula Ln_{(1-y)}Ce_{y}X₃:M wherein 0.0001≦y≦1. Ln is at least one lanthanoid element and X is at least one halide. The dopant M is at least one element selected from the group consisting of Li, Na, K, Rb, Ca, Al, Zn, Ga, Be, Mg, Ca, Sr, Ba, Sc, Ge, Ti, V, Cu, Nb, Cr, Mn, Fe, Co, Ni, Mo, Ru, Rh, Pb, Ag, Cd, In, Sn, Sb, Ta, W, Re, Os, Ir, Pt, Au, Hg, Tl and Bi.

US 2008/0011953 A1 also describes a scintillator composition consisting of a matrix and a dopant. The matrix consists of at least one lanthanoid cation and at least one halide anion. The dopant is a mixture of cerium and bismuth. Yttrium, zirconium, palladium and hafnium are not proposed as dopants.

The matrix material thus comprises two cations, namely another lanthanoid besides cerium. Only exceptionally is the lanthanoid itself also cerium so that the matrix is a cerium halide.

### SUMMARY OF THE INVENTION

A need exists for novel scintillation materials which, in particular, can also be in single crystal form and which have improved properties. In addition to an improved light yield, these materials should have a lower intrinsic strain birefringence. Moreover, the refractive index should be uniform throughout the material. It should be possible to produce the improved materials in high yield and simple fashion, and the materials should have improved mechanical properties.

If the scintillation material is a single crystal material, it should be possible to produce it in the form of large single crystals.

According to the invention the aforesaid objectives and requirements are met by use of a scintillation material, which comprises a compound having the empirical formula LnX₃:D, wherein Ln is selected from the group consisting of Sc, Y, La, Ce, Pr, Nd, Pm, Sm, Eu, Gd, Tb, Dy, Ho, Er, Tm, Yb and Lu; and X is F, Cl, Br or I, and wherein at least one dopant is selected from the group consisting of Y, Zr, Pd, Hf and Bi and is contained in the scintillation material in an amount of 10 ppm to 10,000 ppm. However if the base material is cerium bromide and the dopant includes bismuth, the scintillation material contains at least one additional dopant selected from the group consisting of yttrium, zirconium, hafnium and palladium.

The scintillation material preferably consists of the compound having the previously stated empirical formula, which means that no other substances are added to the initial mixture of the needed components and dopants. However the term “consists of” is not meant to exclude impurities usually present in the material depending on the raw material used, but which do not materially or substantially affect its properties.

The scintillation material of the invention can be single-crystalline or polycrystalline. A single-crystalline material is preferred, because according to the invention single crystals can be produced in a preferred size.

If the material is polycrystalline, the individual crystals should possibly be arranged so as to bring about an isotropic performance of the material.

The present invention provides scintillation materials that make it possible to produce large single crystals. The present invention even makes it possible to produce single crystals having a volume greater than 5 cm³. In principle suitable processes for producing single crystals are known to those skilled in the art. These are, for example, the Bridgman and Czochralski processes. They involve heating the starting halides with one or more dopants to produce a melt which is then cooled to induce crystallization.

At the same time, the scintillation materials of the invention can be produced in high yields. The light yield of the finished materials also increases because according to the invention these materials contain considerably lower amounts of impurities. The impurities are, in particular, oxygen or residual water.

The decay time of the scintillation materials is shortened.

According to the invention at least one dopant selected from the group consisting of Y, Zr, Hf, Pd and Bi is added to the scintillation material in an amount from 10 ppm to 10,000 ppm.

Preferably the dopant or dopants are present in the scintillation material in an amount from 50 ppm to 5,000 ppm and more preferably in an amount from 100 ppm to 1000 ppm.

Because the ionic radius of dopant D differs from that of the cations of the Ln group, local strains are generated in the host crystal. Until now it was assumed that such local strains are disadvantageous. Surprisingly, however, we have now found that these strains increase the lattice energy to an extent such that the critical energy for fissuring or fissure propagation is clearly increased.

During the crystal-growing process, these local strains lead to fewer lattice defects. The thermal strains caused by the gradients needed for growth are not removed by the defects (elastic rather than plastic strain degradation). This leads to lower thermal straining of the crystal during the cooling process.

Moreover, the lower defect concentration brings about a decrease in the non-radiative transitions and thus an increase in the light yield, particularly without negatively affecting the other scintillation properties, such as the decay time and energy resolution. In preferred embodiments, the at least one dopant D is present in the scintillation material of the invention in an amount of 500 ppm to 5,000 ppm. Particularly preferred is a content of 100 ppm and especially one that is higher than 500 ppm and extends up to an upper limit of 1,000 ppm.

It has been found that the scintillation material of the invention has particularly advantageous properties when the Ln element, which is present in cationic form, is selected from the group consisting of La, Ce, Lu, Pr and Eu. Ln is preferably La and/or Ce.

The anion X is preferably Cl, Br or I and more preferably Cl or Br. Most preferably, the scintillation material of the invention is doped CeBr₃. When the dopant in this material is bismuth, the cerium bromide contains at least one additional dopant selected from the group consisting of yttrium, zirconium, hafnium and palladium.

Doped lutetium iodide and doped lanthanum bromide doped are also preferred scintillation materials according to the invention.

Scintillation materials of the previously described compositions containing the dopants of the invention distinguish themselves by a pronounced hardness, even at temperatures close to their melting point. This results in fewer lattice defects and fewer strains.

Besides it being possible to harden the lattice by doping, the mechanical ruggedness of the scintillation material can be increased by an appropriate cooling regime and/or an annealing step in the manufacturing process. In this manner, major strains are removed.

Hence, it is preferred that in a manufacturing process for the scintillation material of the present invention the cooling conditions are as described in the following procedure. The cooling rate is preferably below 20 K/h, more preferably 10 K/h and most preferably 5 K/h within the temperature range between the crystal-growing temperature and 100° C. In the following temperature range from 100° C. to 25° C. the cooling rate is preferably less than 40 K/h, more preferably 20 K/h and most preferably 10 K/h. By maintaining these conditions, the maximum temperature gradient in the crystal is less than 10 K/cm, preferably less than 5 K/cm and most preferably less than 2 K/cm.

For annealing, a uniform temperature is used with a temperature of at the most 10 K, preferably 50 K and at the most 100 K below the melting temperature of the material. The temperature gradient is less than 2 K/cm, preferably less than 1 K/cm and most preferably less than 0.5 K/cm. The heating and cooling rates for the annealing step are to be selected as in the cooling process.

The scintillation material thus obtained distinguishes itself by a low strain birefringence of less than 1 μm/cm, preferably less than 50 nm/cm, and most preferably less than 10 nm/cm. Appropriate annealing markedly improves not only the strain birefringence, but also the uniformity of the refractive index. In this manner, PV values better than 10⁻³ can be achieved.

To prevent oxygen penetration into the crystal, carbon-containing gases, preferably carbon halides and particularly CCl₄, CBr₄ or Cl₄, are added to the crystal-growing atmosphere. Depending on the crystal-growing conditions, particularly the pressure and temperature, these gases react with the oxygen with formation of carbon oxyhalides, which accumulate in the gas atmosphere and are not incorporated into the crystal. The crystal obtained is thus nearly oxygen-free.

Oxyhalide compounds of the rare earths, in particular, cannot be formed under these conditions. A crystal obtained in this manner is characterized by an oxygen content of less than 1000 ppm.

According to the invention the background radiation of the scintillation material is less than 0.5 Bq/cm³, which is made possible by the high purity of the material. Impurities that contribute to radioactive background radiation are also avoided by selecting starting compounds of adequate purity.

### EXAMPLES

The following examples illustrate the invention and the corresponding manufacturing processes. In particular, those skilled in the art are able to select an appropriate furnace. Also, those skilled in the art are able to select another process besides the Bridgman process for making the crystals.

### Example 1

To prepare a material according to the invention, in a glove box filled with argon, 500 g of cerium bromide, 0.26 g of BiBr₃ (corresponding to 0.125 g of bismuth) and 0.29 g of HfBr₃ (corresponding to 0.125 g of hafnium) were weighed out in a quartz ampoule having an internal diameter of 30 mm, with water and oxygen present in the atmosphere in an amount of less than 5 ppm. The ampoule was then evacuated, filled with argon to 50 mbar and sealed. A 30 mm-long capillary with an internal diameter of 3 mm was inserted into the tip of the ampoule. The ampoule was placed into a 3-zone Bridgman furnace. At first, the temperature was kept at 780° C. for 48 h. Then, a crystal was grown at a withdrawing rate of 1 mm/h. The ampoule was then opened in the glove box, and the crystal was removed.

### Example 2

To prepare a material according to the invention 500 g of cerium bromide and 0.58 g of HfBr₃ (corresponding to 0.25 g of hafnium) were weighed out into a quartz ampoule having an internal diameter of 30 mm in a glove box filled with argon, with water and oxygen present in the atmosphere in an amount of less than 5 ppm. The ampoule was then evacuated, filled with argon to 50 mbar and sealed. A 30 mm-long capillary with an internal diameter of 3 mm was inserted into the tip of the ampoule. The ampoule was placed into a 3-zone Bridgman furnace. At first, the temperature was kept at 780° C. for 48 hours. Then, a crystal was grown at a withdrawing rate of 1 mm/h. The ampoule was then opened in the glove box, and the crystal was removed.

The crystals obtained as described in the examples showed a 10% higher hardness than non-doped crystals produced in similar fashion.

While the invention has been illustrated and described as embodied in scintillation materials in single crystal or polycrystalline form with improved properties, especially light yield and strain birefringence, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

We claim:

1. A scintillation material comprising a compound of the general empirical formula
LnX₃:D,
wherein Ln is at least one element selected from the group consisting of Sc, Y, La, Ce, Pr, Nd, Pm, Sm, Eu, Gd, Tb, Dy, Ho, Er, Tm, Yb and Lu; X is F, Cl, Br or I, and D is at least one cationic dopant comprising one or more of elements Y, Zr, Pd, Hf and Bi and is contained in the material in an amount of 10 ppm to 10,000 ppm; with the proviso that, when the scintillator material comprises cerium bromide and said at least one cationic dopant comprises Bi, said at least one cationic dopant also includes at least one of the elements Y, Zr, Pd and Hf.

2. The scintillation material according to claim 1, consisting of said compound having said general empirical formula LnX₃:D.

3. The scintillation material according to claim 1, containing 50 ppm to 10,000 ppm of said at least one cationic dopant.

4. The scintillation material according to claim 1, containing 100 ppm to 1,000 ppm of said at least one cationic dopant.

5. The scintillation material according to claim 1, in single-crystalline form.

6. The scintillator material according to claim 1, in polycrystalline form.

7. The scintillation material according to claim 1, wherein Ln is selected from the group consisting of lanthanum, lutetium and praseodymium.

8. The scintillation material according to claim 1, wherein Ln is Ce and X is Br.

9. The scintillation material according to claim 1, wherein X is Cl or Br.
